(19) United States
(12) Patent Application Publication
(10) Pub. No.: US 2017/0248275 A1
(43) Pub. Date: Aug. 31, 2017

(54) PRESSURE-REGULATED GAS SUPPLY VESSEL

(71) Applicant: Entegris, Inc., Billerica, MA (US)

(72) Inventors: Joseph R. Despres, Middletown, CT (US); Joseph D. Sweeney, New Milford, CT (US); Anthony M. Avila, Austin, TX (US)

(21) Appl. No.: 15/516,576

(22) PCT Filed: Oct. 1, 2015
(86) PCT No.: PCT/US2015/053473

§ 371 Date: Apr. 3, 2017

Related U.S. Application Data
(60) Provisional application No. 62/059,536, filed on Oct. 3, 2014.

(51) Int. Cl. F17C 13/04; F17C 1/00

(52) U.S. Cl. CPC F17C 13/04; F17C 1/00; F17C 2201/058; F17C 2205/0323; F17C 2205/0338; F17C 2205/035; F17C 2205/0391; F17C 2225/0123; F17C 2270/0518; F16K 17/00

(57) ABSTRACT

A gas storage and dispensing vessel, including a vessel container definishing a gas storage interior volume, and a valve head regulator assembly secured to the vessel container, the valve head regulator assembly including a single gas pressure regulator disposed in the interior volume of the vessel container, and a valve head including a pneumatic flow control valve, wherein the single regulator is configured with a set point pressure of at least 0.5 MPa, and wherein the interior volume of the vessel container is at least 5 L.

### CROSS-REFERENCE TO RELATED APPLICATION

The benefit of priority under 35 U.S.C. §119 of U.S. Provisional Patent Application No. 62/059,536 filed Oct. 3, 2014 is hereby claimed. The disclosure of U.S. Provisional Patent Application No. 62/059,536 is hereby incorporated herein by reference, in its entirety, for all purposes.

### FIELD

The present disclosure relates to pressure-regulated gas supply vessels for storage and dispensing of gases, to process systems comprising same, and to methods of making and using same.

### DESCRIPTION OF THE RELATED ART

In the field of gas supply packages for storage and dispensing of high-value gases, a wide variety of designs have evolved, beyond the scope of conventional high-pressure gas cylinders.

The gas supply vessels described in U.S. Pat. Nos. 6,101,816; 6,089,027; and 6,343,476 issued to Luping Wang, et al. and commercially available from Entegris, Inc. (Billerica, Massachusetts, USA) under the trademark VAC are one example, in which one or more gas pressure regulators may be disposed in an interior volume of a gas supply vessel, to provide for dispensing of gas at low pressure, subatmospheric pressure, for applications such as ion implantation in which low pressure gas sources are desired to supply dopant source gas to ion implantation apparatus that is operated at corresponding low pressure.

In general, pressure-regulated gas supply vessels of such type have been commercialized as relatively small-sized gas supply packages, e.g., 2.2 L gas storage volume packages that are configured to supply gas at pressures on the order of 500 torr (0.67 bar).

### SUMMARY

The present disclosure relates to pressure-regulated gas supply vessels, systems comprising such vessels, and methods of making and using such vessels.

In one aspect, the disclosure relates to a gas storage and dispensing vessel, comprising a vessel container defining a gas storage interior volume, and a valve head regulator assembly secured to the vessel container, the valve head regulator assembly comprising a single gas pressure regulator disposed in the interior volume of the vessel container, and a valve head including a pneumatic flow control valve, wherein the single regulator is configured with a set point pressure of at least 0.5 MPa, and wherein the interior volume of the vessel container is at least 5 L.

In another aspect, the disclosure relates to a gas storage and dispensing vessel as described above, in combination with a gas cabinet in which the gas storage and dispensing vessel is disposed.

In a further aspect, the disclosure relates to a gas storage and dispensing vessel as described above, in combination with (i) a gas box in which the gas storage and dispensing vessel is disposed, and (ii) a process tool that is configured to operate at an elevated voltage in relation to the gas box, wherein the process tool is arranged to receive gas from the gas storage and dispensing vessel disposed in the gas box.

A further aspect of the disclosure relates to a method of enhancing operation of a gas-utilizing process facility, comprising supplying for use in the gas-utilizing process facility gas packaged in a gas storage and dispensing vessel.

Other aspects, features and embodiments of the disclosure will be more fully apparent from the ensuing description and appended claims.

### BRIEF DESCRIPTION OF THE DRAWINGS

FIG. 1 is a schematic representation of a pressure-regulated gas supply vessel according to one embodiment of the present disclosure.

FIG. 2 is a front elevation view of a valve head regulator assembly of the pressure-regulated gas supply vessel of FIG. 1.

FIG. 3 is a sectional elevation view of the regulator of the valve head regulator assembly of FIG. 2.

FIG. 4 is a schematic representation of an N-type wafer production system employing a pressure-regulated gas supply vessel as shown in FIG. 1.

FIG. 5 is a schematic representation of a process system including a gas cabinet containing pressure-regulated gas supply vessels of the disclosure, for delivery of gas to three process chambers.

FIG. 6 is a schematic representation of a process system including a gas cabinet containing pressure-regulated gas supply vessels of the disclosure, for delivery of gas to a process chamber, and a separate gas supply source.

FIG. 7 is a schematic representation of a flat-panel display manufacturing system including a gas box containing pressure-regulated gas supply vessels of the disclosure, arranged to deliver gas to an ion implantation tool.

### DETAILED DESCRIPTION

The present disclosure relates to the pressure-regulated gas supply vessels, systems comprising same, and associated methods.

The pressure-regulated gas supply vessels that have been commercialized generally have been of small-volume character, e.g., having a gas supply volume in the vessel container of 2.2 L. Such small-volume pressure-regulated vessels have been commercialized with valve heads including a manually operable flow control valve located downstream of the pressure regulators in the vessel. This valve head construction reflected a perceived need for the manually operable flow control valve as a safety requirement, so that an individual handling the vessel could verify and ensure leak-tight closure of the manual valve. At the same time, the small-volume character of the pressure-regulated gas supply vessel was considered to address safety considerations, with respect to the total volume of superatmospheric pressure gas stored in the vessel that could be released to the ambient environment of the vessel in a worst-case release (WCR) event. The typical arrangement therefore involved a small-volume vessel including a valve head assembly including a manual flow control valve with an internal regulator configured to open when the regulator was exposed to a subatmospheric pressure condition at its outlet.

The present disclosure reflects the finding that larger-volume pressure-regulated vessels can be provided, of highly safe and efficient character, utilizing a single pressure regulator interiorly disposed in the vessel with a set point pressure of at least 0.5 MPa, e.g., in a range of from 0.5 MPa to 1.5 MPa, when such interiorly disposed pressure regulator is part of a valve head assembly that includes a pneumatic flow control valve. The volume for containing gas in such vessels may be at least 5 L, e.g., on the order of from 40 L to 220 L, to provide a high efficiency gas supply package. The gas contained in the interior volume of the vessel may be at superatmospheric pressure above the set point of the single regulator, and in various embodiments, such pressure may be in a range of from 4 MPa to 14 MPa, and more preferably from 7 MPa to 10 MPa. In a specific embodiment, the pressure of the contained gas may be on the order of 9.5 MPa (1380 psia).

The gas stored in and dispensed from the pressure-regulated vessels of the disclosure may be of any suitable type, and may for example comprise gases useful in the manufacture of semiconductor products, flat-panel displays, and solar panels. Such gases may include single component gases as well as multicomponent gas mixtures.

Illustrative gases that may be contained in the pressure-regulated gas supply package of the disclosure include, without limitation, arsine, phosphine, nitrogen trifluoride, boron trifluoride, boron trichloride, diborane, trimethylsilane, tetramethylsilane, disilane, silane, germane, organometallic gaseous reagents, hydrogen selenide, hydrogen telluride, stibine, chlorosilane, germane, disilane, trisilane, methane, hydrogen sulfide, hydrogen, hydrogen fluoride, diboron tetrafluoride, hydrogen chloride, chlorine, fluorinated hydrocarbons, halogenated silanes (e.g., SiF₄) and disilanes (e.g., Si₂F₆), GeF₄, PF₃, PF₅, AsF₃, AsF₅, He, N₂, O₂, F₂, Xe, Ar, Kr, CO, CO₂, CF₄, CHF₃, CH₂F₂, CH₃F, NF₃, COF₂, etc., as well as mixtures of two or more of the foregoing, and isotopically enriched variants thereof.

Accordingly, in one embodiment, the disclosure relates to a gas storage and dispensing vessel, comprising a vessel container defining a gas storage interior volume, and a valve head regulator assembly secured to the vessel container, the valve head regulator assembly comprising a single gas pressure regulator disposed in the interior volume of the vessel container, and a valve head including a pneumatic flow control valve, wherein the single regulator is configured with a set point pressure of at least 0.5 MPa, and wherein the interior volume of the vessel container is at least 5 L.

In specific embodiments, the set point pressure of the single regulator in such vessel may be in a range of from 0.5 MPa to 1.5 MPa. The interior volume of the vessel container in various embodiments may be in a range of from 40 L to 220 L. In other embodiments, the interior volume of the vessel container may be in a range of from 5 L to 15 L, or in a range of from 15 L to 50 L, or in a range of from 50 L to 200 L, or in other specific ranges or sub-ranges within a broad range of 5 L to 220 L or more.

The valve head of the gas storage and dispensing vessel may comprise a 2 port valve head including an output port and a fill port, as hereinafter more fully described.

The gas storage and dispensing vessel may contain gas in the interior volume of the vessel container, and such gas may be a single component gas or a multicomponent gas, and may for example comprise gas selected from the group consisting of arsine, phosphine, nitrogen trifluoride, boron trifluoride, boron trichloride, diborane, trimethylsilane, tetramethylsilane, disilane, silane, germane, organometallic gaseous reagents, hydrogen selenide, hydrogen telluride, stibine, chlorosilane, germane, disilane, trisilane, methane, hydrogen sulfide, hydrogen, hydrogen fluoride, diboron tetrafluoride, hydrogen chloride, chlorine, fluorinated hydrocarbons, halogenated silanes, SiF₄, halogenated disilanes, Si₂F₆, GeF₄, PF₃, PF₅, AsF₃, AsF₅, He, N₂, O₂, F₂, Xe, Ar, Kr, CO, CO₂, CF₄, CHF₃, CH₂F₂, CH₃F, NF₃, COF₂, mixtures of two or more of the foregoing, and isotopically enriched variants of the foregoing.

The gas storage and dispensing vessel may be deployed in combination with a gas cabinet in which the gas storage and dispensing vessel is disposed, in specific embodiments.

In other embodiments, the gas storage and dispensing vessel may be deployed in combination with (i) a gas box in which the gas storage and dispensing vessel is disposed, and (ii) a process tool that is configured to operate at an elevated voltage in relation to the gas box, wherein the process tool is arranged to receive gas from the gas storage and dispensing vessel disposed in the gas box.

The gas storage and dispensing vessel may be operatively coupled to a float zone crystallization apparatus to receive gas from the gas storage and dispensing vessel, in specific embodiments.

In other embodiments, the gas storage and dispensing vessel may be operatively coupled to an ion source for delivery of gas thereto.

In one illustrative implementation, the disclosure contemplates a flat-panel display manufacturing process system, comprising a gas storage and dispensing vessel of the present disclosure, operatively arranged to supply gas for manufacture of flat-panel display products.

The disclosure in a further aspect contemplates a method of enhancing operation of a gas-utilizing process facility, comprising supplying for use in the gas-utilizing process facility gas packaged in a gas storage and dispensing vessel according to the present disclosure. The process facility may comprise an ion implantation process facility, e.g., wherein the ion implantation process facility utilizes dopant gas supplied from the gas storage and dispensing vessel. The process facility in other embodiments may comprise a silicon wafer production facility. In still other embodiments, the process facility may comprise a semiconductor manufacturing process facility, e.g., in which the semiconductor manufacturing process facility comprises an etching process tool utilizing etchant gas supplied from said gas storage and dispensing vessel.

In specific aspects of the method of enhancing operation of the gas-utilizing process facility wherein gases supplied as packaged in a gas storage and dispensing vessel in accordance with the present disclosure, the supplied gas may be of any suitable type. In one embodiment, the gas may comprise phosphine, e.g., in a mixture of phosphine and argon. In another illustrative embodiment, the gas may comprise fluorine, e.g., in a mixture of fluorine and argon for etching applications.

It will be recognized that the gas storage and dispensing vessel of the present disclosure may be configured in a wide variety of ways, and may be usefully employed for packaging of a correspondingly wide variety of gases for gas-utilization applications of varied types.

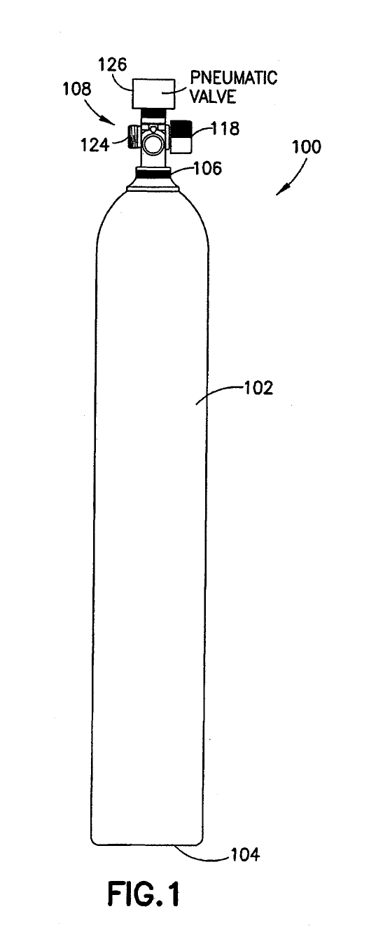

Referring now to the drawings, FIG. 1 is a schematic representation of a pressure-regulated gas supply vessel 100 according to one embodiment of the present disclosure. The pressure-regulated gas supply vessel 100 comprises a vessel container 102 with a flat bottom portion 104 enabling the vessel to be vertically supported on a floor or other flat surface. The vessel container 102 is of elongate cylindrical form, with an upper convergent neck 106 in which is disposed the valve head assembly 108, including a valve body with a fill port 118 and an outlet 124, and a pneumatic valve 126.

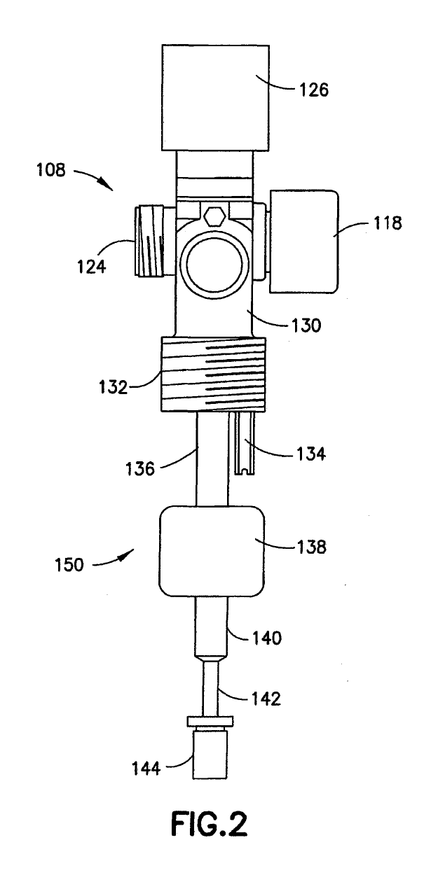

FIG. 2 is a front elevation view of a valve head regulator assembly 108 of the pressure-regulated gas supply vessel of FIG. 1. As shown, the valve head regulator assembly 108 includes a valve head body 130 comprising the aforementioned fill port 118 and outlet 124, with the pneumatic valve 126 coupled with the valve head body and arranged to translate a valve element in the valve head body between fully open and fully closed positions in response to corresponding pneumatic actuation of the pneumatic valve. The valve body 130 includes a threaded cylindrical portion 132 that is threaded for matable engagement with correspondingly threaded interior mating surface of the neck of the vessel in which the valve head regulator assembly is disposed (see FIG. 1).

The valve head regulator assembly includes a fill passage 134 communicating with the fill port 118. The fill port 118 is normally closed by the illustrated closure element thereon, and can be selectively coupled with a source of gas to be stored in and subsequently dispensed from the pressure-regulated vessel. The valve head body 130 at the lower end of the threaded cylindrical portion 132 is coupled to a discharge tube 136 of the pressure regulator assembly 150. The pressure regulator assembly 150 comprises pressure regulator 138, discharge tube 136 leak-tightly joined to pressure regulator 138 at its downstream end, and inlet tube 140 leak-tightly joined to pressure regulator 138 at its upstream end. Inlet tube 140 at its lower end in the orientation shown is joined to the extension tube 142 having a flange at its lower end to which is secured a particle filter 144. The particle filter 144 serves to remove particulates from the gas being discharged from the vessel in which the valve head regulator assembly is disposed, during dispensing operation thereof.

The valve head regulator assembly thus provides a gas flow path for discharge of gas from associated vessel in which it is installed. When gas is being stored in the vessel under non-dispensing conditions, the gas in the vessel container is at pressure higher than the set point of the regulator 138, and the pneumatic valve 126 is closed, and the pressure sensing assembly of the regulator maintains the valve in the regulator inlet in a closed condition so that no gas flow therethrough takes place. When the pneumatic valve 126 is opened, and the pressure sensing assembly in the regulator is exposed to a downstream pressure that is below the set point pressure of the regulator, the pressure sensing assembly will be translated in the regulator to open the valve in the regulator inlet. Gas then will flow through the particle filter 144, extension tube 142, regulator 138, discharge tube 136 and the gas flow passages in the valve head body 130, to the outlet 124 for discharge from the vessel.

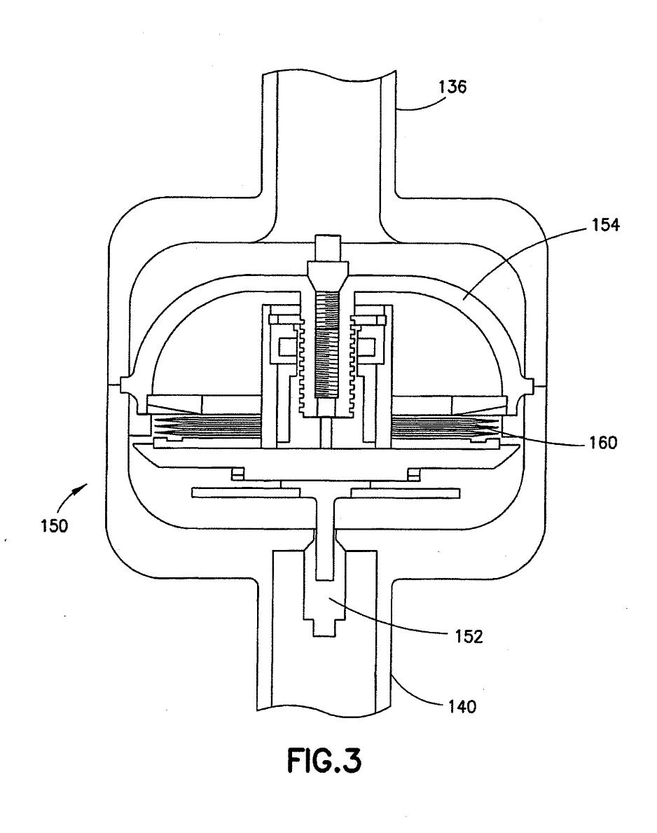

FIG. 3 is a sectional elevation view of the regulator of the valve head regulator assembly 150 of FIG. 2, showing the details of the internal structure thereof As illustrated, the pressure sensing assembly 154 is coupled to an expansible/contractile bellows 160 that expands or contracts in response to outlet pressure conditions, translating the poppet valve element 152 so that the pressure of the gas is maintained at the set point pressure value during dispensing when the valve opens, and so that the poppet valve element 152 is seated to prevent flow of gas through the regulator when the downstream pressure is above the set point of the regulator.

Accordingly, when the downstream pressure in discharge tube 136 is below the set point of the regulator, gas from the gas volume in the vessel container flows through the inlet tube 140 and through the regulator to discharge tube 136.

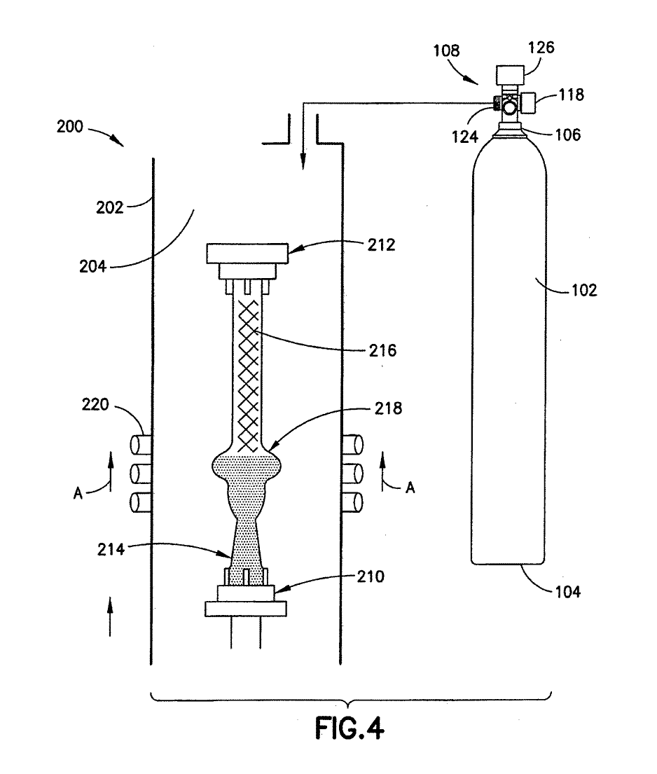

FIG. 4 is a schematic representation of an N-type wafer production system employing a pressure-regulated gas supply vessel as shown in FIG. 1.

The wafer production system includes a float zone crystallization apparatus 200 including a chamber 202 defining an interior volume 204 in which is disposed an upper chuck 212 and lower chuck 210. In the corresponding float zone crystallization process, a polycrystalline silicon rod 216 is touched to a seed crystal 214 disposed on the lower chuck 210. A radio-frequency coil 220 is translated in the direction indicated by arrows A so that the rod in proximity to the coil is melted, with a “melt front” moving from the seed crystal to the end of the rod and back, as the coil is translated to the elevation of the upper chuck 212 and then reversed in direction to the lower chuck 210. The result of this operation is the production of a single crystal rod.

As illustrated, a vessel of the type shown in FIG. 1, wherein corresponding parts and components are correspondingly numerically identified, is arranged for flow of gas into an inlet at the upper end of the float zone crystallization chamber 202, for flow downwardly therein. For the production of single crystal n-type materials for production of corresponding n-type silicon wafers, the gas delivered by the pressure-regulated vessel contains an n-type dopant source material, phosphine (PH₃) in an inert gas such as argon. The phosphine concentration in the phosphine/argon gas mixture may be on the order of 500 ppm PH₃.

The corresponding gas mixture delivery pressure may be on the order of 0.69 MPa (100 psi), with the pressure being determined by the set point pressure of the single regulator in the vessel container 102 at such pressure value.

FIG. 5 is a schematic representation of a process system 300 including a gas cabinet 302 containing in the interior volume 304 of the gas cabinet a pair of pressure-regulated gas supply vessels 306 and 308 in accordance with the disclosure, for delivery of gas to the three process chambers 326, 332, and 338.

As shown, the vessels 306 and 308 are arranged for dispensing communication with manifold line 310, which in turn communicates with the dispensing line 312. The vessels 306 and 308 may be arranged for concurrent or sequential operation, as desired. The dispensing line 312 conveys dispensed gas to the external pressure regulator 314 for pressure modulation and the flow in feed line 316 to the manifold line 320. From the manifold line 320 the dispensed gas flows in the respective branch feed lines 322, 328, and 334 containing mass flow controllers 324, 330, and 336, respectively, to process chambers 326, 332, and 338, respectively.

The gas supplied by the vessels 306 and 308 may comprise a gas mixture such as that described in connection with FIG. 4, or a single component or other multicomponent gas, as appropriate to the process chambers 326, 332, and 338, and the processing operations conducted therein. The pressure of the gas in the feed line 316 may be on the order of 0.7-0.8 MPa, with consistent set point pressures of the regulator's interiorly disposed in the pressure-regulated vessels 306 and 308 in the gas cabinet 302.

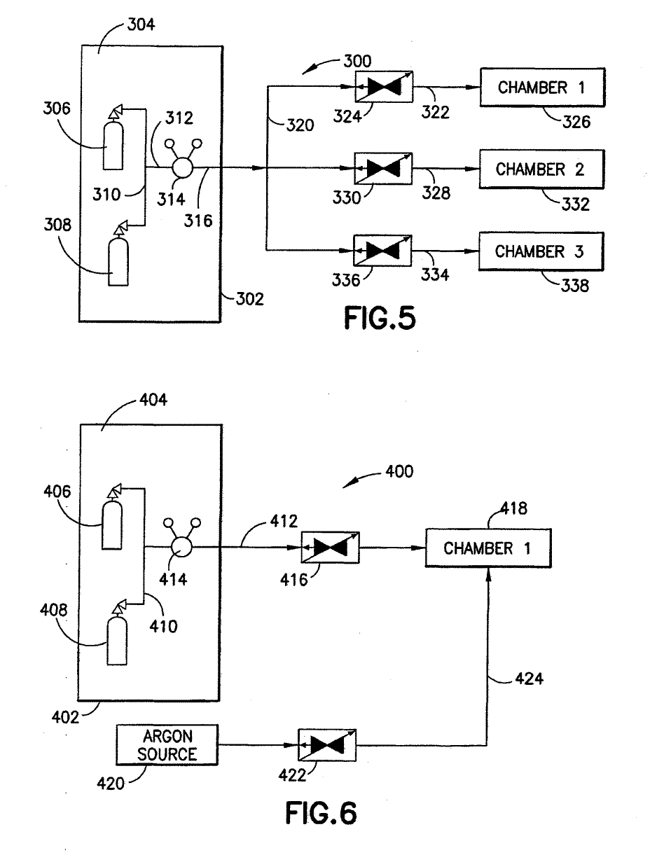

FIG. 6 is a schematic representation of a process system 400 including a gas cabinet 404 containing pressure-regulated gas supply vessels 406 and 408 in accordance with the disclosure, for delivery of gas to a process chamber 418, and a separate gas supply source 420. The pressure-regulated gas supply vessels 406 and 408 as shown supply gas to the manifold 410 for flow in delivery line 412 containing external pressure regulator 414 and mass flow controller 416 to the chamber 418. The vessels 406 and 408 may contain phosphine with the regulators therein having a set point pressure on the order of 0.7 MPa. The separate gas supply source 420 may contain argon or other suitable inert gas that flows in feed line 424 containing mass flow controller 422 to the process chamber 418. The respective flow rates of the phosphine and argon gases may be controlled to provide a desired concentration of phosphine in the process chamber 418, e.g., a concentration in a range of from 40 ppm to 150 ppm in the argon gas in the process chamber.

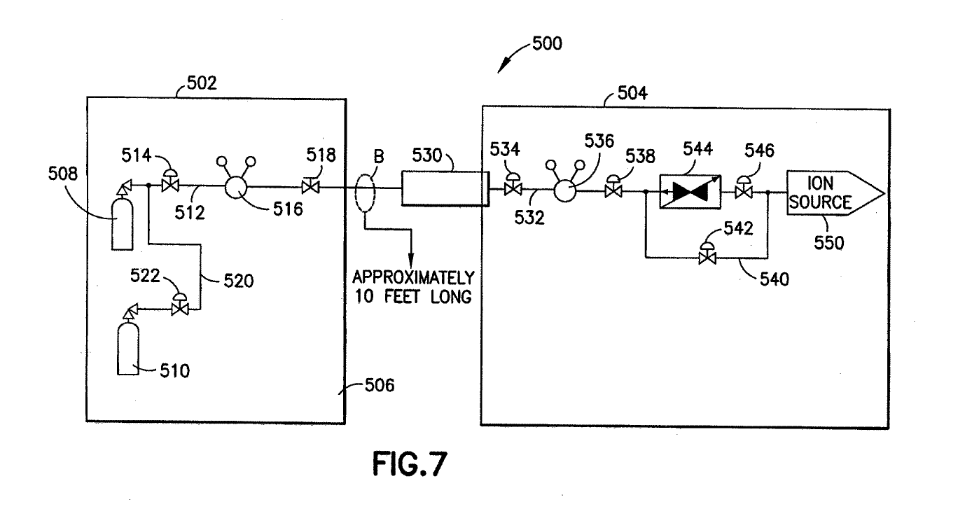

FIG. 7 is a schematic representation of a flat-panel display manufacturing system 500 including a gas box 502 defining an enclosed volume 506 in which is disposed pressure-regulated gas supply vessels 508 and 510 in accordance with the disclosure, arranged to deliver gas to an ion implantation tool 504.

As illustrated, the gas box 502 contains the vessels 502 and 510 in an arrangement enabling sequential operation, so that as one vessel is depleted, the other may be placed on stream to dispense gas to the ion implantation tool 504. Thus, vessel 508 is coupled to gas dispensing line 512 containing flow control valve 514, external regulator 516, and manual valve 518, and vessel 510 is arranged to dispense gas to branch line 520 containing flow control valve 522, with branch line 522 being coupled at its terminal and to the gas dispensing line 512.

The gas dispensing line 512 exterior to gas box 502 denoted schematically by the dashed circle “B” has a length of approximately 10 feet and discharges gas for flow through the dielectric bulkhead 530 to the ion implantation tool 504, whose enclosure is at elevated voltage relative to ground and thus at higher voltage than gas box 502. In the ion implantation tool enclosure, gas supplied by the gas box 502 flows in line 532 through the external regulator 536 flanked by flow control valves 534 and 538, and through mass flow controller 544 and flow control valve 546 to the ion source 550 of the tool. Line 532 also communicates with bypass loop 540 containing flow control valve 542, to enable selective bypass of the introduced gas, around mass flow controller 544 and flow control valve 546.

The gas supplied by the pressure-regulated gas supply vessels 508 and 510 in the process system 500 may comprise isotopically enriched boron trifluoride or other suitable gas, supplied at pressure on the order of 0.8 MPa from the respective gas supply vessels, consistent with the set point pressure of the single regulator in each of the respective gas supply vessels.

It will be recognized that the foregoing process installations utilizing pressure-regulated vessels of the present disclosure are of an illustrative character only, and that such pressure-regulated vessels may be utilized in process installations and applications of widely varied types, to provide gas in a safe, efficient, and reliable manner.

While the disclosure has been set forth herein in reference to specific aspects, features and illustrative embodiments, it will be appreciated that the utility of the disclosure is not thus limited, but rather extends to and encompasses numerous other variations, modifications and alternative embodiments, as will suggest themselves to those of ordinary skill in the field of the present disclosure, based on the description herein. Correspondingly, the disclosure as hereinafter claimed is intended to be broadly construed and interpreted, as including all such variations, modifications and alternative embodiments, within its spirit and scope.

What is claimed is:

1. A gas storage and dispensing vessel, comprising a vessel container defining a gas storage interior volume, and a valve head regulator assembly secured to the vessel container, the valve head regulator assembly comprising a single gas pressure regulator disposed in the interior volume of the vessel container, and a valve head including a pneumatic flow control valve, wherein the single regulator is configured with a set point pressure of at least 0.5 MPa, and wherein the interior volume of the vessel container is at least 5 L.

2. The gas storage and dispensing vessel of claim 1, wherein the set point pressure of the single regulator is in a range of from 0.5 MPa to 1.5 MPa.

3. The gas storage and dispensing vessel of claim 1, wherein the interior volume of the vessel container is in a range of from 40 L to 220 L.

4. The gas storage and dispensing vessel of claim 1, wherein the valve head comprises a 2 port valve head including an outlet port and a fill port.

5. The gas storage and dispensing vessel of claim 1, containing gas in the interior volume of the vessel container at pressure in a range of from 4 MPa to 14 MPa.

6. The gas storage and dispensing vessel of claim 5, wherein said gas is a single component gas.

7. The gas storage and dispensing vessel of claim 5, wherein said gas is a multicomponent gas.

8. The gas storage and dispensing vessel of claim 5, wherein said gas comprises gas selected from the group consisting of arsine, phosphine, nitrogen trifluoride, boron trifluoride, boron trichloride, diborane, trimethylsilane, tetramethylsilane, disilane, silane, germane, organometallic gaseous reagents, hydrogen selenide, hydrogen telluride, stibine, chlorosilane, germane, disilane, trisilane, methane, hydrogen sulfide, hydrogen, hydrogen fluoride, diboron tetrafluoride, hydrogen chloride, chlorine, fluorinated hydrocarbons, halogenated silanes, SiF₄, halogenated disilanes, Si₂F₆, GeF₄, PF₃, PF₅, AsF₃, AsF₅, He, N₂, O₂, F₂, Xe, Ar, Kr, CO, CO₂, CF₄, CHF₃, CH₂F₂, CH₃F, NF₃, COF₂, mixtures of two or more of the foregoing, and isotopically enriched variants of the foregoing.

9. The gas storage and dispensing vessel of claim 1, in combination with a gas cabinet in which the gas storage and dispensing vessel is disposed.

10. The gas storage and dispensing vessel of claim 1, in combination with (i) a gas box in which the gas storage and dispensing vessel is disposed, and (ii) a process tool that is configured to operate at an elevated voltage in relation to the gas box, wherein the process tool is arranged to receive gas from the gas storage and dispensing vessel disposed in the gas box.

11. The gas storage and dispensing vessel of claim 1, operatively coupled to a float zone crystallization apparatus to receive gas from the gas storage and dispensing vessel.

12. The gas storage and dispensing vessel of claim 1, operatively coupled to an ion source for delivery of gas thereto.

13. A flat-panel display manufacturing process system, comprising a gas storage and dispensing vessel according to claim 1, operatively arranged to supply gas for manufacture of flat-panel display products.

14. A method of enhancing operation of a gas-utilizing process facility, comprising supplying for use in the gas-utilizing process facility gas packaged in a gas storage and dispensing vessel according to claim 1.

15. The method of claim 14, wherein the process facility comprises an ion implantation process facility.

16. The method of claim 15, wherein the ion implantation process facility utilizes dopant gas supplied from said gas storage and dispensing vessel.

17. The method of claim 14, wherein the process facility comprises a silicon wafer production facility.

18. The method of claim 14, wherein the process facility is a semiconductor manufacturing process facility.

19. The method of claim 18, wherein the semiconductor manufacturing process facility comprises an etching process tool utilizing etchant gas supplied from said gas storage and dispensing vessel.

20. The method of claim 14, wherein the gas comprises phosphine.

21-23. (cance
